(19) United States
(12) Patent Application Publication
(10) Pub. No.: US 2025/0124428 A1
(43) Pub. Date: Apr. 17, 2025

(54) ALTERNATIVE ADVERTS WALLET SYSTEMS AND METHODS FOR ACCESSING DIGITAL CONTENT

(71) Applicant: Rivit TV, Inc., Los Angeles, CA (US)

(72) Inventors: Wade Bradley, Los Angeles, CA (US); Shrikesh Karunakaran Pillai, Thousand Oaks, CA (US); Adam Shaw, Temecula, CA (US)

(21) Appl. No.: 18/911,098

(22) Filed: Oct. 9, 2024

Related U.S. Application Data
(60) Provisional application No. 63/589,951, filed on Oct. 12, 2023.

(51) Int. Cl. G06Q 20/36; G06Q 30/0208; G06Q 30/0601

(52) U.S. Cl. CPC G06Q 20/363; G06Q 30/0208; G06Q 30/0621

(57) ABSTRACT

Methods and systems of providing access to digital content are disclosed. The method includes receiving, from a user device of a user, a request to access digital content. In response to the request, the method further includes providing the user device at least one modal for the user to sign-in or sign-up. The method further includes determining whether the user has signed in or signed up via the at least one modal. In response to determining that the user has signed in or signed up, the method further includes providing the user access to the digital content for a specific time period. The method further includes sending to the user one or more offers. The method further includes providing the user access to a digital wallet. The method further includes storing and providing a display of the one or more offers in the digital wallet.

### CROSS REFERENCE TO RELATED APPLICATIONS

This application claims the benefit of U.S. Provisional Application No. 63/589,951 filed on Oct. 12, 2023, the disclosure of which is incorporated herein by reference.

### TECHNICAL FIELD

The present disclosure relates generally to digital content access. More specifically, the present disclosure is related to alternative adverts wallet systems and methods for accessing digital content.

### BACKGROUND

Most digital content consumers or users express dissatisfaction as most of the content is paywalled or behind a digital wall. Even when a content is free, users are buried in advertisements (also referred to as adverts or ads). Most of the ads presented to the users are irrelevant. This also causes content providers and advertisers to lose money. The ads shown to a user cannot be shared with family, friends, and alike. Moreover, there is no easy way for a user to customize the ads shown. Therefore, there is a need for a better way to access digital content.

### BRIEF DESCRIPTION OF THE DRAWINGS

The drawings are made to point out the unique and inventive nature of the disclosed application and to distinguish the application from prior art. The objects, features and advantages of the application are detailed in the description taken together with the drawings. Within the accompanying drawings, various embodiments in accordance with the present disclosure are illustrated by way of example and not by way of limitation. It is noted that like reference numerals denote similar elements throughout the drawings.

FIG. 1 is a block diagram illustrating an alternative adverts wallet system according to an embodiment.

FIGS. 2A-2B are diagrams illustrating example modals displayed on a publisher site according to an embodiment.

FIG. 3 is a diagram illustrating an example alternative adverts wallet sign-up screen according to an embodiment.

FIG. 4 is a diagram illustrating an example alternative adverts wallet sign-in screen according to an embodiment.

FIGS. 5A-5B are diagrams illustrating an alternative adverts wallet website according to an embodiment.

FIG. 6 is a diagram illustrating an alternative adverts wallet offers view where new offers are concealed according to an embodiment.

FIG. 7 is a diagram illustrating an alternative adverts wallet offers view where a new offer is revealed according to an embodiment.

FIGS. 8A-8B are diagrams illustrating an alternative adverts wallet offers view where users can share or rate an offer according to an embodiment.

FIG. 9 is a diagram illustrating an example view of alternative adverts wallet rewards according to an embodiment.

FIG. 10 is a diagram illustrating an example view of a user's content history in an alternative adverts wallet according to an embodiment.

FIG. 11 is a diagram illustrating an example view of a user's profile in an alternative adverts wallet according to an embodiment.

FIG. 12 is a flow diagram illustrating an example process according to an embodiment.

FIG. 13 is a flow diagram illustrating another example process according to an embodiment.

FIG. 14A is a diagram illustrating an example alternative adverts wallet offers modal displayed on a publisher's website according to an embodiment.

FIG. 14B is a diagram illustrating an example alternative adverts wallet sign-up/sign-in modal according to an embodiment.

FIG. 15 is a flow diagram illustrating yet another example process according to an embodiment.

FIG. 16 is a diagram illustrating an example alternative adverts wallet sign-up/sign-in with offers modal displayed on a publisher's website according to an embodiment.

FIG. 17 is a flow diagram illustrating still another example process according to an embodiment.

FIG. 18 is a diagram illustrating an example alternative adverts wallet with actionable offers modal displayed on a publisher's website according to an embodiment.

FIG. 19 is a flow diagram illustrating another process according to an embodiment.

FIG. 20 is a diagram illustrating an example alternative adverts wallet offers search modal displayed on a publisher's website according to an embodiment.

FIG. 21 is a block diagram illustrating a computing system that may be used to support the systems and operations discussed herein.

FIGS. 22A and 22B are block diagrams illustrating examples of a user personalization system according to an embodiment.

### DETAILED DESCRIPTION

Reference will now be made in detail to various embodiments in accordance with the present disclosure, examples of which are illustrated in the accompanying drawings. While described in conjunction with various embodiments, it will be understood that these various embodiments are not intended to limit the present disclosure. On the contrary, the present disclosure is intended to cover alternatives, modifications and equivalents, which may be included within the scope of the present disclosure as construed according to the claims. Furthermore, in the following detailed description of various embodiments in accordance with the present disclosure, numerous specific details are set forth in order to provide a thorough understanding of the present disclosure. However, it will be evident to one of ordinary skill in the art that the present disclosure may be practiced without these specific details or with equivalents thereof. In other instances, well known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present disclosure, a procedure, logic block, process, or the like, is conceived to be a self-consistent sequence of operations or instructions leading to a desired result. The operations are those utilizing physical manipulations of physical quantities. Usually, although not necessarily, these quantities take the form of electrical or magnetic signals capable of being stored, transferred, combined, compared, and otherwise manipulated in a computing system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving”, “providing”, “determining”, “sending”, “storing” or the like, refer to actions and processes of a computing system or similar electronic computing device or processor. The computing system or similar electronic computing device manipulates and transforms data represented as physical (electronic) quantities within the computing system memories, registers or other such information storage, transmission or display devices.

Various embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

An alternate adverts (AADS) wallet systems and methods for accessing digital content for free from websites or apps are described. For example, users may agree to receive product offerings in a digital (or virtual) wallet instead of payments to access digital content. In one embodiment, users may be presented with one or more products or brands that they can select to receive offerings. Users can customize their product preferences in the wallet, which may be used to customize products or brands presented to the user. Other methods where the user can customize their preferences for selecting products to receive offerings are described. Users can like, share, and rank offers in the AADS wallet. Users may earn rewards or reward coins for using the AADS wallet system. Rewards or reward coins can be spent for purchases or shared with other users. Users can access their history in the AADS wallet system.

In one aspect, a method of providing access to digital content are provided. The method may include receiving, from a user device of a user, a request to access digital content. In response to the request, the method may further include providing the user device at least one modal for the user to sign-in or sign-up. The method may further include determining whether the user has signed in or signed up via the at least one modal. In response to determining that the user has signed in or signed up, the method may further include providing the user access to the digital content for a specific time period. The method may further include sending to the user one or more offers. The method may further include providing the user access to a digital wallet. The method may further include storing and providing a display of the one or more offers in the digital wallet.

In another aspect, a server system is provided. The server system may include one or more processors and at least one memory coupled to the one or more processors. The at least one memory stores instructions, which when executed by the one or more processors, cause the server system to perform operations. The operations may include receiving, from a user device of a user, a request to access digital content. In response to the request, the operations may further include providing the user device at least one modal for the user to sign-in or sign-up. The operations may further include determining whether the user has signed in or signed up via the at least one modal. In response to determining that the user has signed in or signed up, the operations may further include providing the user access to the digital content for a specific time period. The operations may further include sending to the user one or more offers. The operations may further include providing the user access to a digital wallet. The operations may further include storing and providing a display of the one or more offers in the digital wallet.

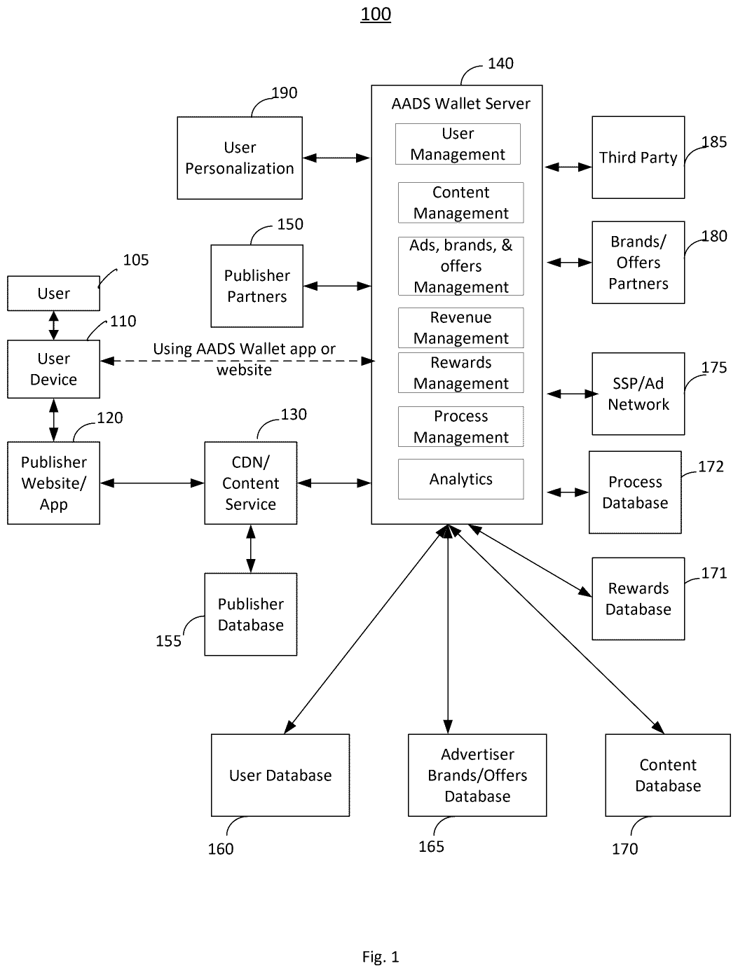

FIG. 1 is a block diagram illustrating an alternative adverts wallet system according to an embodiment. Referring to FIG. 1, system 100 may include, but not limited to, user device 110, publisher website or app 120, publisher partners services 150, user personalization system 190, content delivery network (CDN) or content service 130, publisher database 155, AADS wallet server 140, user database 160, advertiser brands or offers database 165, content database 170, third party service 185, brands or offers partners services 180, supply-side-platform (SSP) or ad network 175, process database 172, and rewards database 171.

In an embodiment, user 105 may use user device 110 to access digital content. Digital content may include, but not limited to, news articles, textual information (e.g., scientific articles or papers, poems, essays, op-eds), games, in-game purchases, art (e.g., non-fungible token (NFT)), literary works, videos, music, podcasts, etc., available on a website, app, or device to be consumed by the viewer in an electronic format. A publisher may be a digital content provider, and publisher website or app 120 may be a digital content provider's website or app. User device 110 may be a smartphone, tablet, laptop, computer, smartwatch, game console, smart television (TV), streaming device, etc., used to access, view, or consume digital content from websites or apps. User 105, using device 110, may access content from publisher website or app 120. For example, user 105 may click on an article, try to make an in-game purchase, listen to a podcast, or download an app or game, etc. User 105's request for digital content may be relayed to CDN/content service 130 via the Internet. CDN 130 may include a geographically distributed group of servers that helps minimize delays in accessing digital content by reducing the physical distance between a server and the user device 110. CDN 130 may store digital content fetched from publisher database 155, which may hold or store digital content. In an embodiment, in response to user 105 accessing content on publisher website or app 120, an AADS wallet modal may be displayed (e.g., on publisher website or app 120). In another embodiment, an AADS wallet app may be invoked. AADS wallet server 140 may be networked, for example, on cloud server(s). The AADS wallet modal or app may be fetched from the wallet server 140 via CDN 130. Modals or modal windows may be user interface (UI) elements that sit on top of the application's main window.

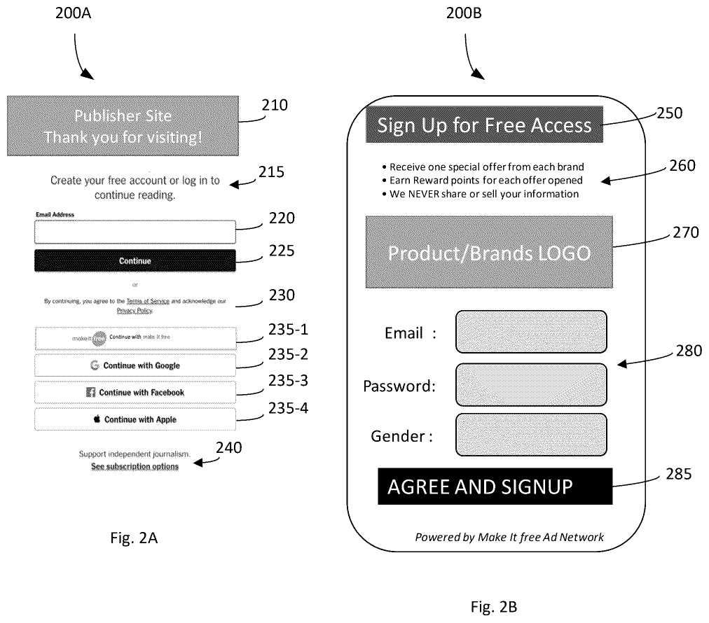

FIGS. 2A-2B are diagrams illustrating example modals displayed on a publisher site according to an embodiment. In FIG. 2A, an example modal 200A may be displayed on the publisher website 120 requesting user 105 to sign up (or sign in) to access (e.g., read) the digital content. Modal 200A may display a header message 210 (e.g., with phrases “Publisher Site”, “Thank you for visiting”) and ask user 105 to create an account 215 (e.g., by displaying the phrase “Create your free account or log in to continue reading.”). Modal 200A may include an email field 220 for user 105 to enter their email address and select button 225 to sign in or sign up. Modal 200A may include one or more buttons 235-1 to 235-4 to allow easy sign-in using other existing accounts (e.g., make it Free™, Google®, Facebook®, Apple®). Modal 200A may show subscription or payment options 240 (e.g., with the phrase “Support independent journalism. See subscription options”). Other messages or links 230 may be displayed, providing user access to terms of service and privacy policy. Modal 200A may originate from publisher 120, allowing user 105 to sign in/sign-up to the publisher website 120 and may be referred to as a paywall modal or a paywall or a digital wall.

Once user 105 agrees (e.g., by clicking button 225 on modal 200A), an AADS wallet modal is shown to user 105. FIG. 2B is an example of AADS wallet modal 200B originating from AADS wallet server 140, asking user 105 to sign in (or sign up) to the AADS wallet system to access the content (which may be for a limited period). Referring to FIG. 2B, modal 200B may include a heading 250 summarizing a purpose (e.g., “Sign-up for Free Access”), an offer conditions and benefits message 260, UI element 270 (which may include the phrase “Product/Brands LOGO”), sign-in/sign-up fields 280, and button 285 to agree and complete the sign-up. Offer conditions and benefits message 260 may summarize what user 105 may be required to agree to receive free digital content access and the benefits of availing of this service. In this example, user 105 may be required to agree to receive an offer from each brand shown in the UI element 270. UI element 270 may show product names, pictures, videos, sound clips, logos, etc. Product may include a physical product (e.g., shoe, car, etc.), a digital product (e.g., software, app, podcast, video, music), a restaurant, airline, travel site, a service, insurance, etc. In an embodiment, modal 200B is shown directly to the user 105 instead of having to first view modal 200A. In an embodiment, the placement and content of the UI elements described are based on user 105's attributes. The attributes are derived from previous user 105 interactions with the AADS wallet system 100. If the user has not previously interacted with System 100 the attributes may be derived from other sources such as the Publisher website/App, user information from existing accounts, etc. For example, UI element 270 may be tailored based on user 105's attributes derived. The number of Products/Brands displayed, the order of display, etc. are tailored. Other UI elements such as Email address 220, Subscription option 240, etc. are customized.

### AADS Wallet Server

Referring to FIG. 1, AADS wallet server 140 may maintain and perform several functions or processes, such as user management, content management, SSP (supply-side platform) and advertisers management, brands and offers management, revenue management, analytics, fraud detection, and/or rewards management. To assist with these management functions, AADS wallet server 140 may maintain several databases, such as user database 160, advertiser brands/offers database 165, content database 170, rewards database 171, and process database 172. In some embodiments, AADS wallet server 140 and the databases can be distributed on cloud server(s). Server 140 may track user details and preferences, user history, advertiser or brand offers, and content details. Server 140 may track attributes of user 105, such as age, gender, geographic locations, sign-in (login) details, sign-in history, preferences for brands or products, content preferences and history, offer history (e.g., preferences, likes, sharing, rating, usage, etc.), rewards usage and history, friends and family of user 105 (e.g., from sharing history), wallet website or app history, etc. The attributes of user 105 can be obtained directly from user 105, inferred, or derived. Server 140 may use user database 160 to manage and track the user attributes.

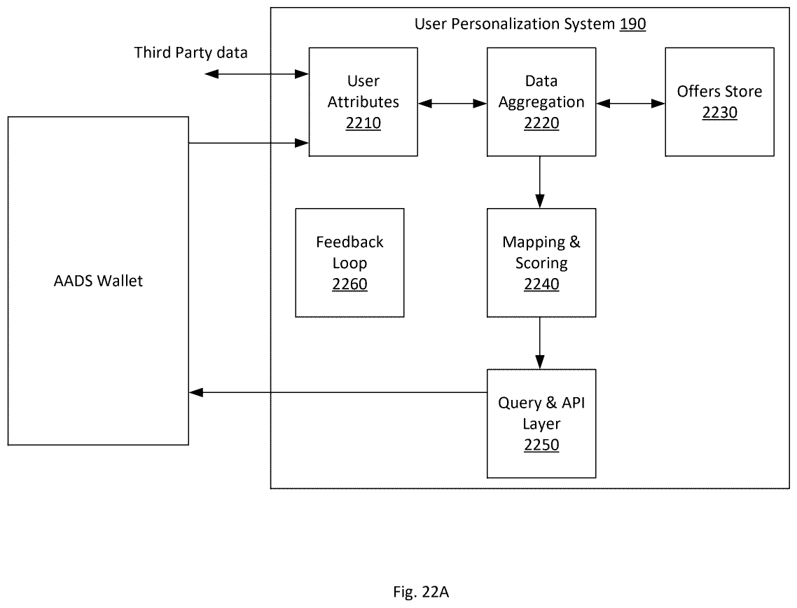

FIG. 21 is a block diagram showing a computing system that may be used to support the systems and operations discussed herein. Referring to FIG. 21, computing system 2100 includes at least one CPU (central processing unit) 2120, GPU (graphical processing unit) 2140, AI (artificial intelligence) processors 2150, volatile and non-volatile memory 2110, storage 2130 (e.g., solid state drive (SSD), redundant array of independent disk (RAID), removable storage), network interface 2170 (e.g., Ethernet, WiFi, etc.) to communicate with other devices, and input/output (I/O) 2160 (for peripherals such as keyboard, mice, pen, display devices, universal serial bus (USB), etc.).

When a user accesses digital content from publisher website or app 120, a request is sent to server 140 with details of the content and the user (such as login, name, demographics, digital details-cookie information, browser fingerprints, browser, IP address, device, display) via CDN server 130. Server 140 may update content database 170 and user database 160 with these details. In an embodiment, content management of server 140 may check to see if user 105 has permission to access the requested content (e.g., from a previous transaction). Server 140 may query tools or servers from third-party service 185 to check if the user 105 has access. If user 105 has access to the requested content, server 140 provides access to the user. On the other hand, server 140 may invoke its ads brands and offers management functions if the user 105 is not permitted. Using user history, preferences, and analytics functions, server 140 may query SSP/ad network 175 and advertiser brands/offers database 165 to gather products or brands to display to user 105. For example, these products or brands may be displayed as part of UI element 270 of modal 200B. Server 140 may update user database 160, advertiser brands/offers database 165, and content database 170.

### Revenue Management

Publishers typically earn payments for displaying products/brands modal (for example, in modal 200B). Publisher may receive payments for validated display or subsequent actions by the user on the AADS modal. The payment amount may be determined based on agreements with publisher partners services 150. Publisher partners can be publishers who agree to provide AADS wallet services to their users. The payment amount may be computed using several methods, including:
Number of AADS modals displayed to users on the publisher website or app 120.
Number of user clicks on the product/brands in the AADS modal and subsequent action on the modal.

AADS wallet server 140 may also compute money an advertiser owes to AADS wallet system 100 based on agreements with brands/offers partners services 180. Brand/offer partners services 180 may include all product (or brand), manufacturers (or creators), and their affiliates who want to advertise their product offers to users via the AADS wallet system 100. Money owed by the advertisers may be computed using several methods, including:
Number of displays of offer/brand logo in the AADS modal.
User interaction with products/brands in the AADS modal.
User view and click on the offer in the AADS wallet.
User clicks on the offers in the AADS wallet and subsequent actions specified in the offer, such as completing a download of an app, purchasing a product, or signing up on a platform.

The revenue management function inside server 140 manages payments owed to the publishers and payments owed by the advertisers. The revenue management function periodically computes the payments in the background (e.g., daily, weekly, or monthly). Revenue tallies owed to publishers and advertisers can be accessed through dashboards or reports and periodically shared with publisher partners services 150 and brands/offers partners services 180.

### Fraud Detection

In an embodiment, a separate fraud detection process may authenticate and validate a user and the validity of the modal display and use of the modal. If any fraudulent activity is detected, then the AADS wallet system 100 may turn off the functioning of the modal (e.g., modal 200A or 200B) and may not account for such modal actions toward payment calculation. System 100 may use tools or apps of third-party service 185 for user authentication and fraud detection.

### AADS Wallet Sign Up/Sign in

If user 105 accepts an offer of AADS wallet system 100 (for example, by clicking the button 285, which may be labelled “AGREE AND SIGNUP”, on modal 200B), information of the acceptance of the offer may be sent to server 140 along with any selections or interactions that user 105 made on the products/brands displayed. Server 140 may authenticate user 105 and provide access to the digital content for a limited time period (e.g., two weeks, 48 hours, etc.). In one embodiment, user 105 is provided a link to download an app (e.g., from the App Store or Play Store) or a product. In another embodiment, a link may be provided asking the user to complete a survey, sign up on a site, or request more information. Server 140 may update the relevant databases (e.g., databases 160, 165, 170-172) and update the revenues. Offers may be updated in the wallet of user 105. User 105 can access their AADS wallet by directly communicating with server 140 using the Internet via an AADS wallet app or AADS wallet website. Based on communication preferences of user 105, offers may be sent via email, short message service (SMS), or in the Wallet App.

If the user has not already signed up for the AADS wallet, user 105 may be sent with sign-up details for the AADS wallet. AADS wallet app download details may also be sent to user 105. AADS wallet website details may be sent to user 105. Server 140 may update users database 160, advertisers database 165, content database, and/or rewards database 171.

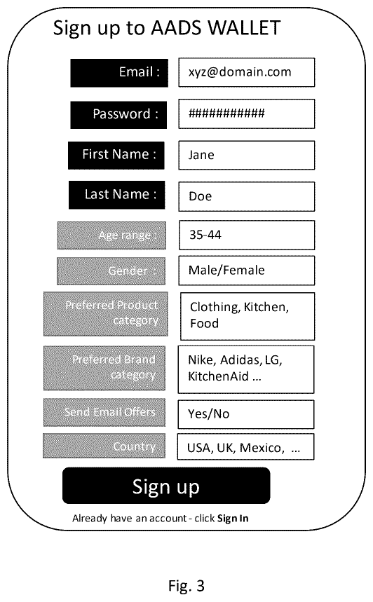

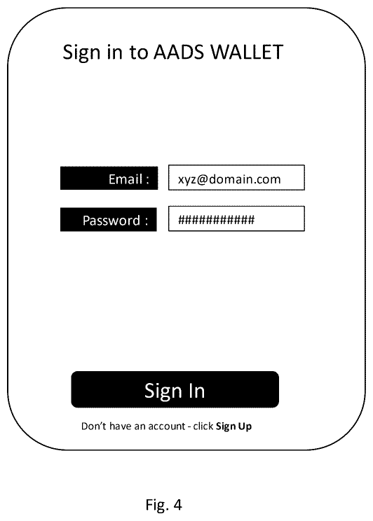

FIG. 3 is a diagram illustrating an example alternative adverts wallet sign-up screen according to an embodiment. Referring to FIG. 3, AADS wallet sign-up may request basic and required information, such as email, password, first name, and last name. Other information, such as age range, gender, preferred product category, preferred brand category, communication preferences (e.g., send email offers, send offers via SMS), and geographical location details may also be requested. If user 105 has previously signed up for an AADS wallet, a sign-in screen is presented, as shown in FIG. 4, which is a diagram illustrating an example alternative adverts wallet sign-in screen according to an embodiment.

### AADS Wallet

In an embodiment, AADS wallet is an app or website of the AADS wallet system where users (e.g., user 105) can access their product offers. Referring back to FIG. 1, AADS wallet system 100 may use user personalization system 190 to present user 105 with offers that can be personalized. The offers may be personalized based on their demographics and AADS wallet usage history. User wallet usage history may include offer view and clicks, like, shares, comments, rating, etc. User wallet history may also include user 105's interaction with email and product/brands websites. Email clicks, for example, can be used to track user 105's preferences. User behavior on product/brand websites or apps, such as time spent, heatmaps, pixel tracking, etc., of user 105 on the product/brand websites or apps can be used to determine user's 105 preferences towards offers, products, or brands. Product purchases resulting from an AADS wallet offer can also be used to determine user 105's preferences. Email clicks, website/app interaction, product purchases, etc. may be a result from user 105's interaction with offers presented in AADS wallet. User demographics include age, gender, income, location, etc.

In an embodiment, offers to be presented to user 105 can be ranked, where offers that user 105 has higher affinity towards have a priority or rank over other offers. User affinity to the offer is determined by the history of user 105's interaction with the offer or similar offers. The ranking or the priority of the offer determines if the offer is presented to user 105. In another embodiment, the ranking of the offer may determine the display attributes of the offer in AADS wallet. In an embodiment, offers are unrevealed (or concealed) or revealed when the user clicks or taps on the offers to select the offers. In an embodiment, concealed offers may be blurred. In another embodiment, offers may be revealed directly or in a different way. User personalization system 190 may add new offers to AADS wallet or change offers previously presented to user in AADS wallet.

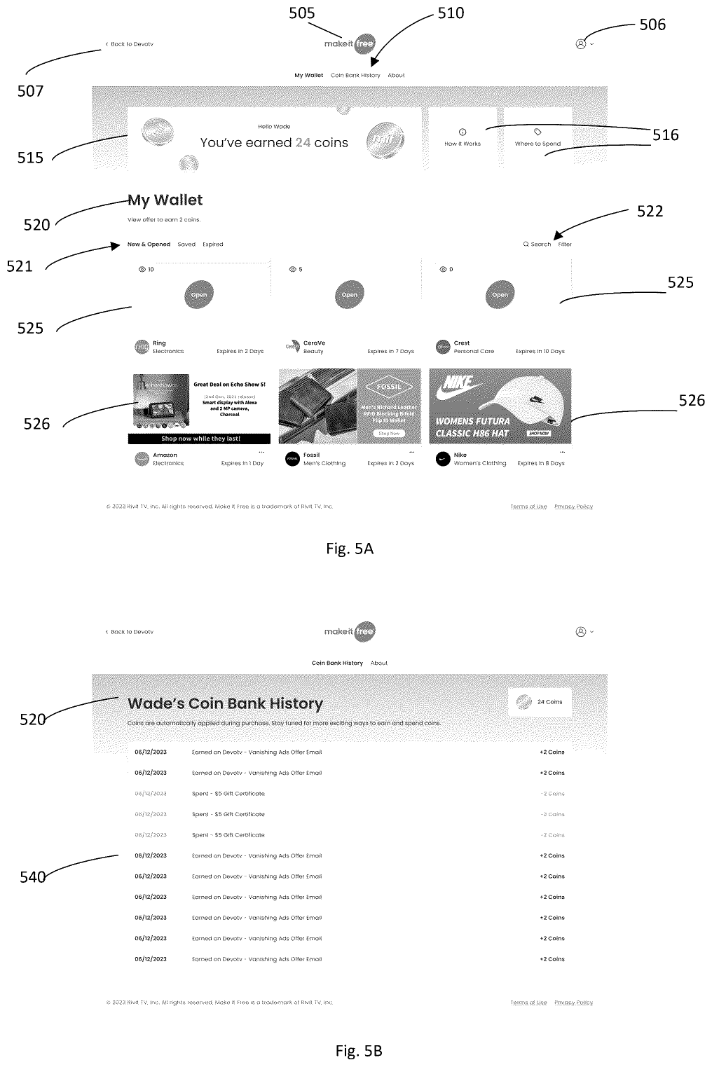

FIGS. 5A-5B are diagrams illustrating an AADS wallet website according to an embodiment. Referring to FIG. 5A, the AADS wallet website may include a site header 505. Header 505 may include a site name (e.g., “make it free”), logos, icon 506 to access profile management, and navigational aids 507. The AADS wallet website may also include a website navigation menu 510. In this example, the website navigation menu 510 includes three options: “My wallet”, “Coin Bank History”, and “About”. FIG. 5A shows the “My Wallet” page, while FIG. 5B shows a “Coin Bank History” page. Underneath the navigation menu is a welcome banner 515 showing the user's name and a summary of rewards earned. In this example, the welcome banner 515 includes a welcome message “Hello Wade” and a summary “You've earned 24 coins”. Welcome banner 515 may also include instructional links 516. Underneath the welcome banner 515 may be page name 520 (which may be referred to as “My Wallet”) with some messages or instructions. In this example, the user is asked to “View offer to earn 2 coins”. Page name 520 may organize the user's offers in three navigational tabs 521, such as “New & Opened”, “Saved”, and “Expired”. Navigation tabs 521 may include aids 522 for filtering or searching. In this example, the offers are organized in a grid fashion, where the top row includes unopened (concealed) offers 525 and the bottom row includes opened (revealed) offers 526. At the bottom of each offer, a product name and a message indicating when the product offer will expire are shown. For concealed offers 525, a user may select (e.g., click or tap on) an offer 525 to reveal the offer. The user can save the offer or share the offer with others. The user can like the offer or rate the offer. These user actions (e.g., saving, sharing, liking, and rating) can help users customize their product preferences. System 100 uses this information to tailor the products/brands displayed to users (for example, in UI element 270 of modal 200B). For the revealed offers 526, actual offer details are provided. FIG. 5B shows an example of a reward history. In this example, a user may earn rewards in coins, though other embodiments are possible, such as reward points and/or virtual currency. Referring to FIG. 5B, the example website provides a tabular summary 540 of the user's reward history.

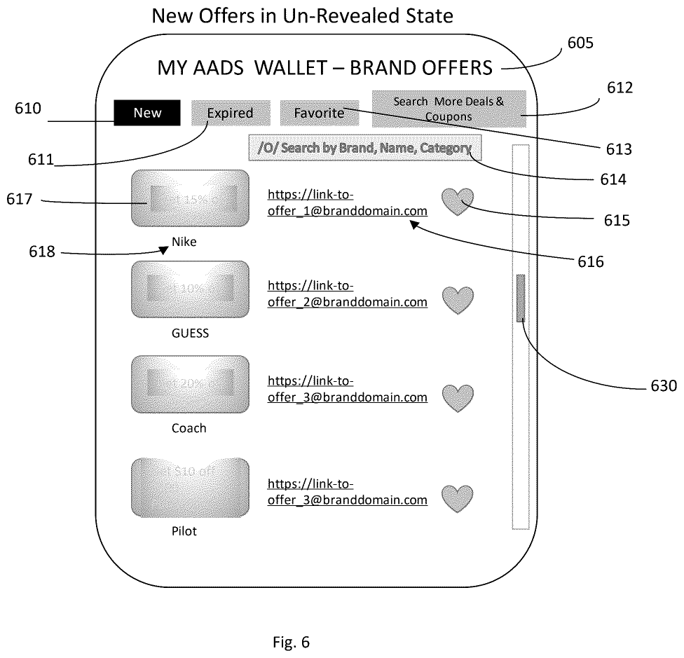

FIG. 6 is a diagram illustrating an AADS wallet offers view where new offers are concealed according to an embodiment. Referring to FIG. 6, user 105 may be presented with a view of unrevealed or concealed new offers with a title 605. Using different unrevealed states, AADS wallet system 100 can gauge user 105's interest in the offer presented (e.g., current and previous offers). Similarly, user 105 by revealing an offer shows their preferences towards the brands and personalize future offers presented. In this example, offers view are organized into different categories, for example, “New” 610, “Expired” 611, and “Favorite” 613. This example shows new offers under “New” 610. A search button 612 may be provided to the user for searching for more deals. When user 105 selects (e.g., clicks or taps on) the search button 612, a new window or modal may be opened or more offers may be shown on the same window. A search field 614 may be provided to user 105 to search the current offers based on different categories, such as “Brand” (e.g., Nike®, Coach®, Guess®, Pepsi®, Lays®, etc.), “Product Name” (e.g., shoes, purses, sodas, chips, etc.), “Category” (menswear, womenswear, footwear, etc.), liked offers, offer expiry date, offer date. In this example, four new offers are shown (though any number of offers can be implemented), where offer detail 617 may be blurred or semi-transparent, name 618 of the brand or product, a link 616, and a symbol 615 to like the offer. When the user selects (e.g., clicks or taps on) offer detail 617, the offer may be revealed. In an embodiment, a picture is displayed instead of link 616. The link 616 associated with the image or a selectable URL link may take the user to the product page where the user can take further steps of availing the offer. In an embodiment, selecting name 618 may take user 105 to the product page. Users can select (e.g., click or tap on) symbol 615 to like the offer. The offer may be added to the user's favorite section. A scroll bar 630 is provided to help user 105 navigate.

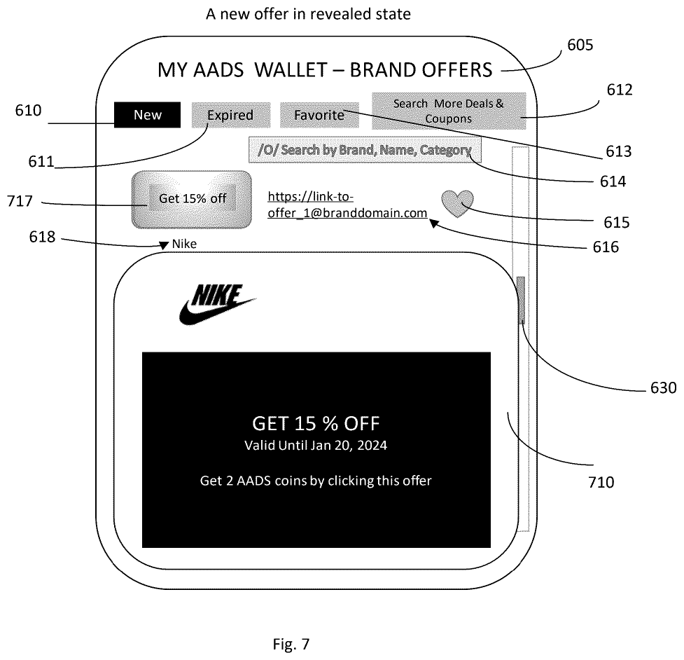

FIG. 7 is a diagram illustrating an AADS wallet offers view where a new offer is revealed according to an embodiment. In FIG. 7, user 105 selects (e.g., clicks or taps on) offer 717 to reveal the offer. In this example, the user is offered 15% off. Upon opening the offer (by selecting revealed offer 717), a popup offer 710 shows complete details of the offer. Clicking on the popup offer 710 or revealed offer 717 may take the user to the product page where the user can avail of the offer.

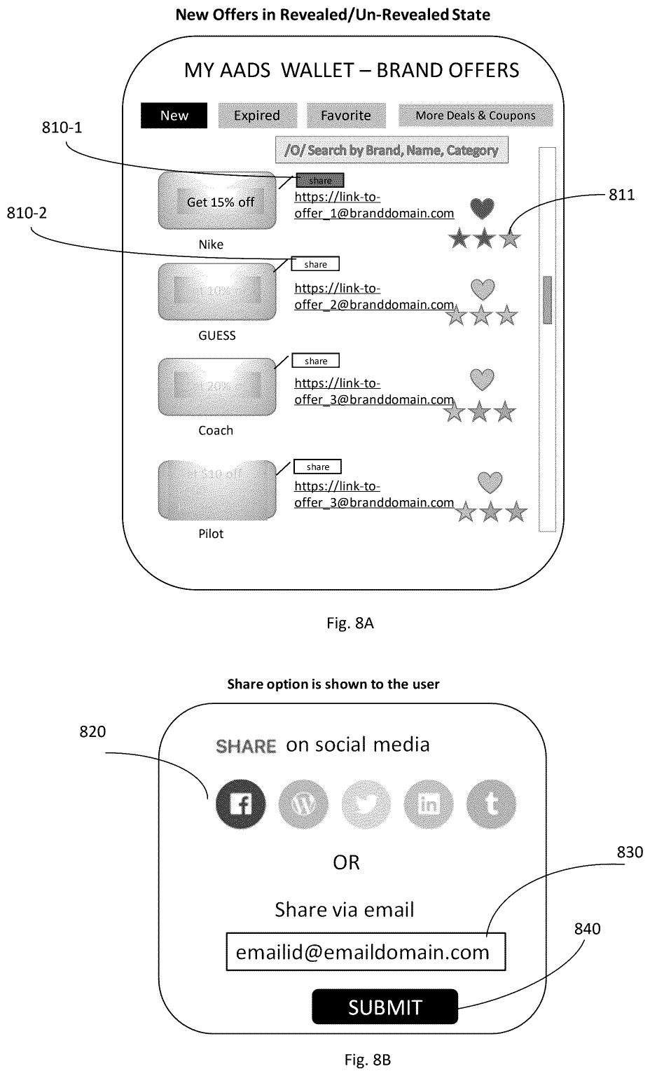

FIGS. 8A-8B are diagrams illustrating an AADS wallet offers view where users can share or rate an offer according to an embodiment. The layout of the example offer view in FIG. 8A is similar to FIG. 6 and FIG. 7. In FIG. 8A, a share button 810 and rating symbol 811 are provided to user 105. In this example, the user may select (e.g., click or tap on) share button 810-1, which may open a new window similar to FIG. 8B. Referring to FIG. 8B, various icons 820 for sharing the offer on social media are provided. An email field 830 and a submit button 840 are provided for sharing the offer with an email address. Referring to FIG. 8A, user 105 can also rate the revealed offers by highlighting the rating symbol 811 (stars in this example). The higher number of rating symbols selected can indicate a higher degree of favorable liking. The number of rating symbols can differ in different scenarios, for example, three, four, five or any number of stars. In this example, the user rates the offer based on a three-star rating system.

### User Rewards or Reward Coins

Rewards may be awarded to users for performing different actions in the AADS system. For example, a user may reveal an offer, select the offer and visit the product page, download an app or product using a link provided in the AADS wallet system, give feedback on an offer, use the offer, or share the offer. Rewards can be used towards purchasing products. Rewards can be donated or shared with other users of the AADS wallet system. Rewards management function or process in AADS wallet server 140 may track and maintain user rewards. Whenever user 105 earns or spends rewards, the rewards management function may update (e.g., add or delete) rewards of user 105 in rewards database 171.

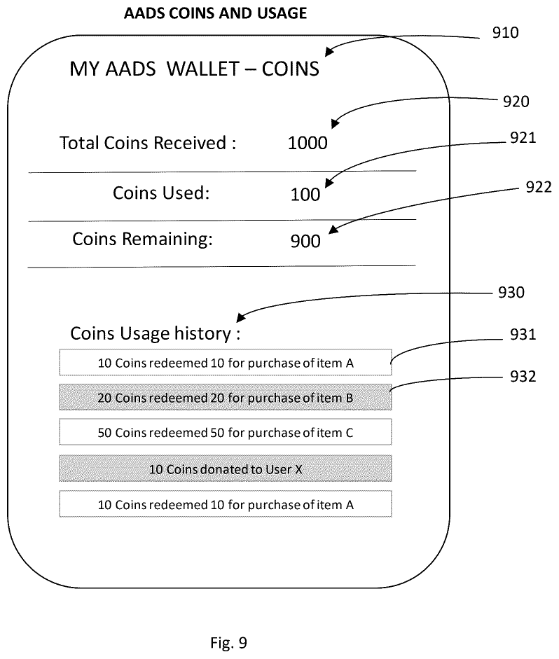

Users can view their rewards balance and history in their AADS wallet. FIG. 9 is a diagram illustrating an example view of AADS wallet rewards according to an embodiment. In this example, reward coins are used. Reward points or virtual currency can be used in other embodiments. Referring to FIG. 9, user 105 is shown their reward view in the AADS wallet. In this example, user 105 is shown a quick summary of a total number of reward coins received 920, a number of coins used 921 (e.g., used for purchases, donated, or shared), and remaining coins 922. The user's usage history 930 is also shown. In this example, a tabular view of the reward transactions is shown. A transaction can be shown using different colors or shades (as shown with reference numerals 931 and 932) to help users distinguish the transaction type. A header 910 that includes the name of the view of the AADS wallet rewards (e.g., “MY AADS WALLET-COINS”) is also shown in this figure.

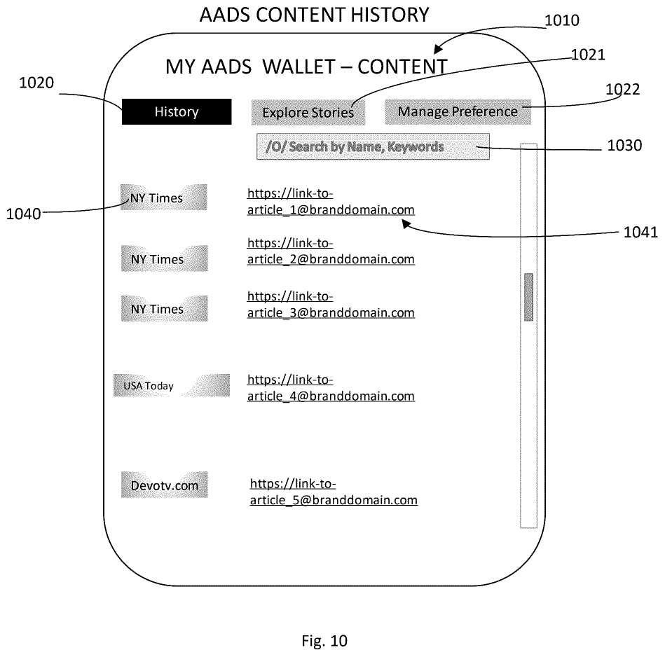

FIG. 10 is a diagram illustrating an example view of a user's content history in an AADS wallet according to an embodiment. Referring to FIG. 10, the content history may include a header 1010. Header 1010 may include the name of the view of the user's content history (e.g., “MY AADS WALLET-CONTENT”). User 105 may be provided with tabbed navigation with a number of tabs, for example, history tab 1020, explore stories tab 1021, and manage preference tab 1022. This example shows five entries in the user's history, though any number of entries may be shown within the view. Each entry may include a publisher's name (e.g., publisher name 1040), and a corresponding link to a product (e.g., link 1041). This example shows news articles in the user's history, though other entries may be shown. Search bar 1030 may be provided to aid users in searching their content history. Explore stories tab 1021 allows users to search for new digital content. If a user selects new content, these details may be saved to the content database 170 by server 140. Using the manage preference tab 1022, user 105 can set their preferences.

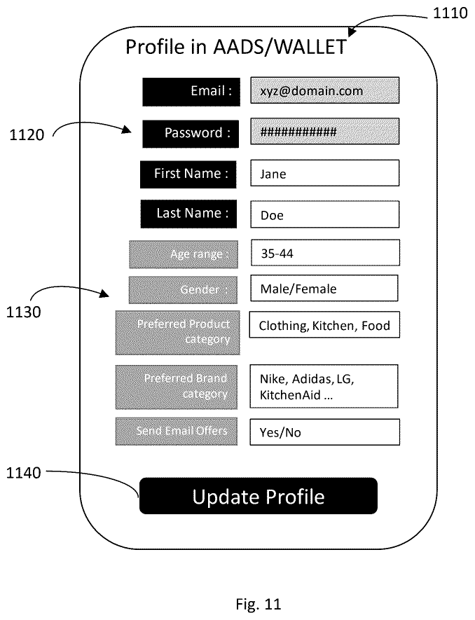

FIG. 11 is a diagram illustrating an example view of a user's profile in an AADS wallet according to an embodiment. Referring to FIG. 11, the example view includes a header 1110 that includes the name of the view (e.g., “Profile in AADS/WALLET”), entries 1120 and 1130, and button 1140 to update the user's profile. As shown, entries 1120 and 1130 can be of different colors or shades to help the user distinguish between required and optional entries. For example, the user may be required to input certain information into entries 1120 (e.g., email, password, first name, and last name), whereas input into entries 1130 may be optional. Using this view, user 105 can update their email address, password, first and last name, age range, gender, product and brand category preferences, communication preferences, location, etc. Information inputted into entries 1120 and 1130 may be updated by server 140 and saved to users database 160.

### AADS Wallet Personalization and Ranking System

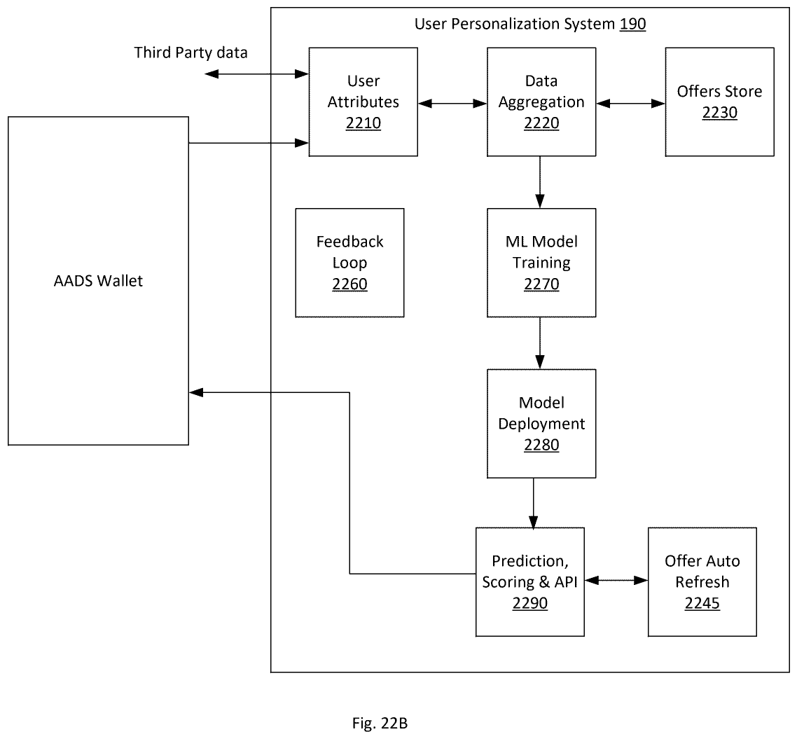

FIGS. 22A and 22B are block diagrams illustrating examples of a user personalization system according to an embodiment. In FIGS. 22A and 22B, user personalization system 190 may present users with offers that can be personalized based on their demographics and AADS wallet usage history. User personalization 190 may rank the offers presented to the users in certain orders. Offers having higher rankings may be presented to the user over the lower ranking offers. The ranking may be based on, for example:
User Wallet Usage History
   Offer selections: offers that the user has selected (e.g., clicked or tapped on),
   Offer views: Offers that user has viewed on the AADS wallet and product/brand website or apps,
   User comments on offers,
   Ratings, likes, and shares: Offers that the user has rated, liked or shared.
User usage history on emails and product/brands websites/apps
   Email opening or viewing from any offer emails generated by AADS wallet to user 105,
   Viewing of Product/brand: User behavior on product/brand websites or apps, such as time spent, heatmaps, pixel tracking, etc., of user 105 on the product/brand websites or apps can be used to determine user's 105 affinity towards an offer, product or brand,
   Product purchases can also be used to determine user 105's preferences.

Referring to FIGS. 22A and 22B, user demographics, wallet history, user usage history (e.g., emails, product apps or websites), user interests history of publications, articles, product, product categories, etc. can be stored as user attributes 2210. User attributes 2210 may be enhanced with third party data from other websites, services, etc. to enable user personalization system 190 get a more thorough ideas of user 105's interests and improve user 105's data quality. For example, the third-party data may be used for new AADS wallet users and may include information such as user demographics. In a different example, third-party data may be used to augment the existing user attributes and may include information of products, services, user interests, etc. availed outside of AADS wallet.

Data aggregation service 2220 may process the user attributes 2210, for example, by cleaning and aggregating the user attributes 2210. Various feature sets can be generated for use by other blocks within the user personalization 190. In an embodiment, data aggregation 2220 may receive user attributes 2210, which may include the third party data. Data aggregation 2220 may also receive data from offers store 2230 for processing, for example, by cleaning and aggregating the data. Offer store 2230 may store offer items and their attributes, retrieval information, etc. Attributes of the offer items may include products, brands, and offer information, such as sales promotions (e.g., “15% off”, “Buy 2 and get 50% off”), offer dates, etc.

Referring to FIG. 22A, mapping and scoring service 2240 may map and score offer items based on data retrieved or received from data aggregation service 2220. Query and application programming interface (API) layer 2250 may allow fetching of personalized user offers based on different attributes. Brand offers that match user profile attributes can be selected from a pool of available offers. Brand offers can be scored (or ranked) based on the number of times a user or users with similar demographics have interacted with the offer (or similar offer). The interaction may include the number of times an offer has been clicked, positive or negative attribution based on comments, user offer ranking, likes, share, brand power, brand popularity, etc. Positively attributed offers can have a higher ranking than negative attributed offers. In an embodiment, during repeat AADS wallet views, user 105's most recent history can be used to show similar items. In an embodiment, feedback loop 2260 may serve as a supervisory process with appropriate checks to improve the overall personalization of the offers presented to user 105 by presenting offers that can generate a positive attribution to the user. Positive attribution includes clicking on the offers, viewing the offers in product apps or websites, positive comments, user ranking, shares, likes, product purchases, etc. In one instance, this involves improving various algorithms used (ML or other) by recording user 105's interactions with AADS wallet, feeding back the data to improve brand offer score.

Referring to FIG. 22B, in an embodiment, user personalization system 190 may use artificial intelligence (AI), such as machine learning (ML), to improve offers presented to user 105 with the goal that offer presented to user 105 have a positive attribution. For example, instead of employing the mapping and scoring service 2240 and the query and API layer 2250, as shown in FIG. 22A, the embodiment of FIG. 22B employs ML model training 2270, model deployment 2280, and prediction, scoring, & API 2290. ML model training 2270 may build ML models having prediction rates for offers that generate a user positive interaction. Model deployment 2280 may deploy a trained ML model to prediction, scoring & API 2290, where prediction, scoring, & API 2290 uses the trained ML model to generate personalized offers to be presented to user 105.

### Wallet Offer Items Auto-Refresh

In an embodiment, as shown in FIG. 22B, offer auto refresh service 2245 of user personalization system 190 can add, or change (refresh) one ore more offers in an AADS wallet. Offer auto refresh service 2245 may determine that certain criteria are met and add new offers. For instance, the criteria may include user completion of an interaction through an AADS modal, availability of an offer, or when special offers are available. In the case where new offers are available from advertisers, system 100 may only add the new offer to the user AADS wallet only if it matches the user personalization.

Existing offers in AADS wallet may be refreshed with other offers when certain criteria are met. Some examples of the criteria may include: current offer has expired and a similar offer is available from the same brand of similar brand, a better offer is available from the same brand or a different brand, user personalization system 190 determines that a better set of offers are available, an error is detected in the offer previously presented or cannot be fulfilled, user actions such as user purchase, or interaction with brand website/app are not trackable while availing the offer.

### Publisher Apps-Content Access Flow

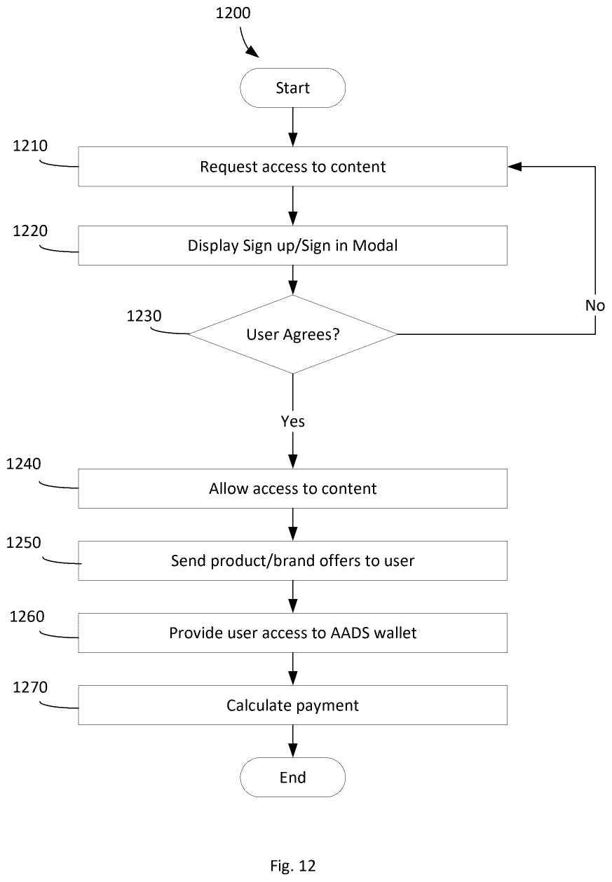

FIG. 12 shows an example process according to an embodiment. Process 1200 may be performed by processing logic that may comprise hardware (circuitry, dedicated logic, etc.), software (such as is run on a general purpose computer system or a dedicated machine), firmware, or a combination. In one embodiment, the process 1200 is performed by user device 110 and/or server 140 of FIG. 1.

Referring to FIG. 12, in operation 1210, user 105 may use user device 110 to request access to digital content from publisher's site or app 120. For example, user 105 may select an article, try to make an in-game purchase, listen to a podcast, or download an app or game, etc. The request may be sent to server 140. The request may include information of the digital content and the user (such as login, name, demographics, digital details-cookie information, browser fingerprints, browser, IP address, device, display, etc.) via CDN server 130. Server 140 may update content database 170 and users database 160 with the information. Server 140 may invoke its ads brands and offers management functions. Using user history, preferences, and analytics functions, server 140 may query SSP/ad network 175 and advertiser brands/offers database 165 to gather the products or brands to display to user 105 on publisher website 120. For example, these products or brands may be displayed as part of UI element 270 in modal 200B. Server 140 may update user database 160, advertiser brands/offers database 165, and content database 170.

In operation 1220, a sign-up/sign-in modal may be displayed to the user, for example, through publisher website or app 120. In an embodiment, two modals may be displayed, similar to modal 200A and modal 200B, shown in FIG. 2A and FIG. 2B, respectively. First, modal 200A may be displayed, and if the user agrees, then modal 200B may be shown. Modal 200A, which may be referred to as a paywall or digital wall, allows user 105 to sign in to the publisher website or app. Modal 200B allows user 105 to sign in to the AADS wallet system. If required, user 105 may be prompted to sign up. In another embodiment, only modal 200B is shown to user 105.

Modal 200B may originate from AADS wallet server 140, and ask user 105 to sign in (or sign up) to the AADS wallet system to access the content (for a limited time period). As previously described, modal 200B may include a heading 250 summarizing the purpose (e.g., “Sign-up for Free Access”), an offer conditions and benefits message 260, UI element 270, sign-in/sign-up fields 280, and button 285 to agree and complete the sign-up. Offer conditions and benefits message 260 may summarize what user 105 may be required to agree to receive free digital content access and the benefits of availing of this service. In this example, user 105 may be required to agree to receive one special offer from each brand shown in the UI element 270. UI element 270 may show product names, pictures, videos, sound clips, logos, etc. A product may include a physical product (e.g., shoe, car, etc.), a digital product (e.g., software, app, podcast, video, music), a restaurant, airline, travel site, a service, insurance, etc.

Still referring to FIG. 12, in operation 1230, it is determined whether user 105 agrees to the conditions presented in the modal during operation 1220. If user 105 agrees to the conditions and signs up/signs in, the processing logic proceeds to operation 1240. Action information of user 105 may be sent to server 140, and any selections or interactions that user 105 made on the products/brands may be displayed. If user 105 does not agree, the processing logic reverts to operation 1210. The user signup information from the AADS modal 1220 may also be used in the AADS wallet signup.

In operation 1240, server 140 may authenticate the user and provide access to the digital content for a limited time period (e.g., two weeks, 48 hours, etc.). Server 140 may update relevant databases with this information.

In operation 1250, personalized product/brand offers may be sent to the user, for example, via email. In one embodiment, user 105 is provided a link to download an app (e.g., from the App Store or Play Store) or a product. In another embodiment, a link may be provided asking the user to complete a survey, sign up on a site, or request more information. Server 140 may update the relevant databases with this information.

In operation 1260, the user may be provided with access to an AADS wallet. Offers may be stored or updated in the AADS wallet. User 105 can access their AADS wallet by directly communicating with server 140 using the Internet via an AADS wallet app or AADS wallet website. Based on user 105 communication preferences, offers may be sent via SMS, other messaging apps/media, or in the wallet app.

If the user still needs to sign up for the AADS wallet, user 105 may be sent with sign-up information for the AADS wallet. AADS wallet app download information may also be sent to user 105. AADS wallet website information may be sent to user 105. Server 140 may update the relevant databases with this information.

In operation 1270, the revenue management function of server 140 may be invoked to calculate payment. The server 140 may calculate payment owed to the publisher and payment owed by the advertisers. Relevant databases may be updated with this information.

### AADS Wallet-User Flow 1

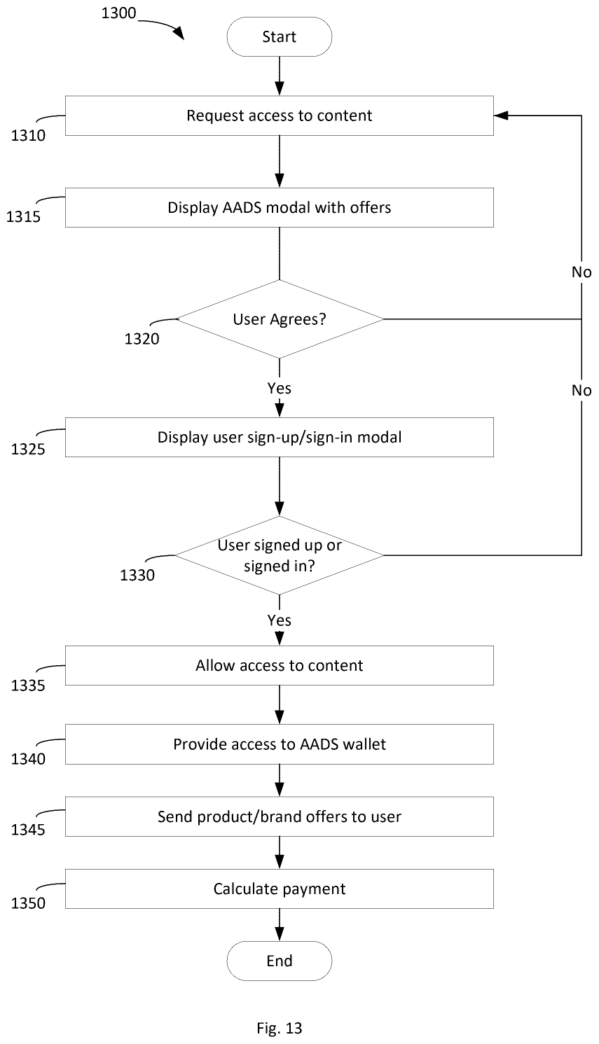

FIG. 13 shows another example process according to an embodiment. Process 1300 may be performed by processing logic that may comprise hardware (circuitry, dedicated logic, etc.), software (such as is run on a general purpose computer system or a dedicated machine), firmware, or a combination. In one embodiment, the process 1300 is performed by user device 110 and/or server 140 of FIG. 1.

Referring to FIG. 13, in operation 1310, user 105 may use user device 110 to request access to digital content from publisher's site or app 120. For example, user 105 may select (e.g., click or tap on) an article, try to make an in-game purchase, listen to a podcast, or download an app or game, etc. The user's request may be sent to server 140. The request sent to server 140 may include information of the content and user information (such as login, name, demographics, digital information, e.g., cookie information, browser fingerprints, browser, IP address, device, display, etc.) via CDN server 130. Server 140 may update content database 170 and user database 160 with these information. Server 140 may invoke its ads brands and offers management functions. Using user history, preferences, and analytics functions, server 140 may query SSP/ad network 175 and advertiser brands/offers database 165 to gather what products or brands to display to user 105 on publisher website 120. Server 140 may update user database 160, advertiser brands/offers database 165, and content database 170.

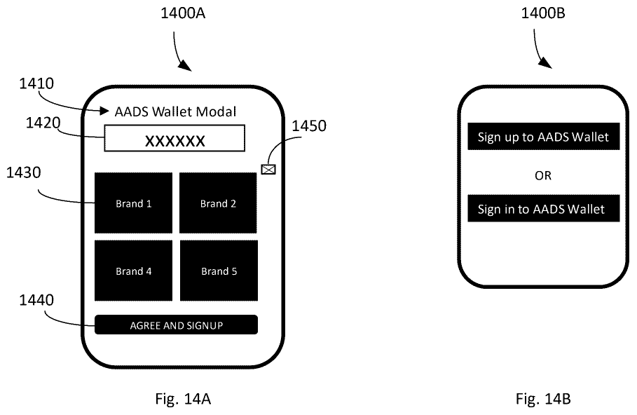

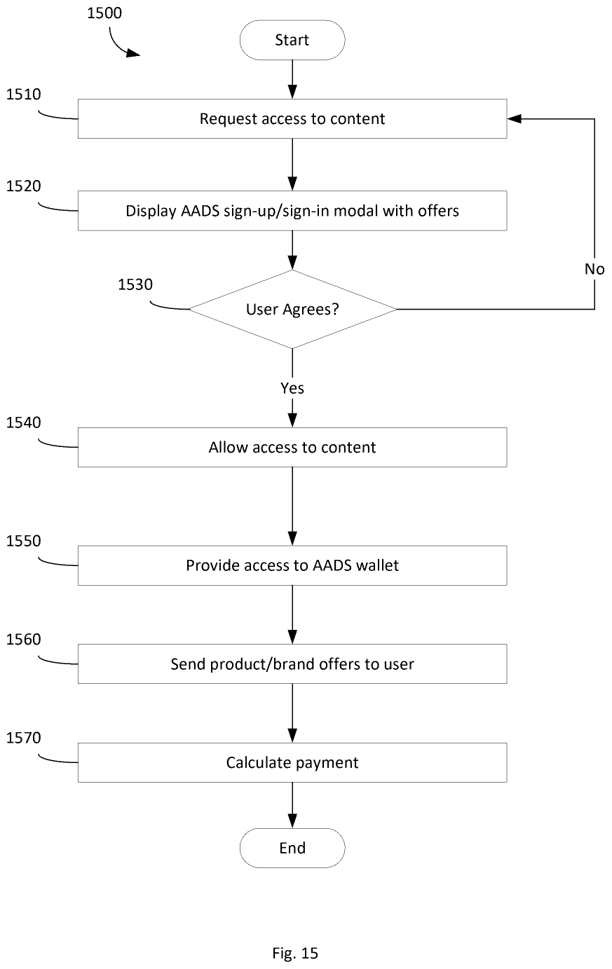

In operation 1315, an AADS wallet modal with offers may be displayed to the user on publisher's website 120. Referring now to FIG. 14A, which is a diagram illustrating an example AADS wallet offers modal displayed on a publisher's website according to an embodiment, modal 1400A may include a header or title 1410, message 1420, at least one brand or product UI element 1430, cancel icon or button 1450, and button 1440 to agree and sign up. In this example, four brands 1430 are displayed. Header 1410 may indicate to the user that the modal 1400A is from an AADS wallet system. Message 1420 may include a brief message on what user 105 may be required to agree to and may provide benefits information. UI element 1430 may show product names, pictures, videos, sound clips, logos, etc. A product may include a physical product (e.g., shoe, car, etc.), a digital product (e.g., software, app, podcast, video, music), a restaurant, airline, travel site, a service, insurance, or any other product. In an embodiment, UI element 1430 is personalized based on user 105's preferences derived by user personalization system 190.

Referring back to FIG. 13, in operation 1320, process 1300 may determine whether user 105 agrees to the conditions presented in the modal (e.g., modal 1400A). If user 105 agrees to the conditions and signs up/signs in, process 1300 proceeds to operation 1325. Action information of user 105 may be sent to server 140, and any selections or interactions that user 105 made on the products/brands may be displayed. If user 105 does not agree, process 1300 reverts to operation 1310.

In operation 1325, an AADS sign-up/sign-in modal may be shown to user 105 on the publisher website or app 120. The AADS sign-up/sig-in modal, for example, may be AADS wallet sign-up/sign-in modal 1400B shown in FIG. 14B.

In operation 1330, process 1300 determines whether user 105 has signed up or signed in to the AADS wallet system. If user 105 has signed up or signed in, the process 1300 proceeds to operation 1335. If the user has not signed up or signed in, the process 1300 reverts to operation 1310.

In operation 1335, server 140 may authenticate the user and provide or allow access to the digital content for a limited time period (e.g., two weeks, 48 hours, etc.). Server 140 may update relevant databases (e.g., databases 160, 165, 170) with this information.

In operation 1340, the user may be provided with access to an AADS wallet. AADS wallet app download details may also be sent to user 105. AADS wallet website details may be sent to user 105. Server 140 may update the relevant databases with this information.

In operation 1345, personalized product/brand offers may be sent to the user. In one embodiment, user 105 may be provided with a link to download an app (e.g., from the App Store or Play Store) or a product. In another embodiment, a link may be provided asking the user to complete a survey, sign up on a site, or request more information. Server 140 may update the relevant databases with this information. Based on user 105 communication preferences, offers may be sent to the user via email, SMS, other messaging apps/media, or in the wallet app.

In operation 1350, the revenue management function of server 140 may be invoked to calculate payment. The server may calculate payments owed to the publisher and payments owed by the advertisers. Relevant databases may be updated with this information.

AADS Wallet-User Flow 1 AADS (Sign-Up/Sign-In Modal with Offers)

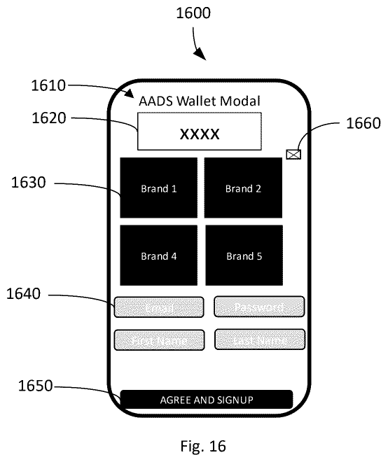

FIG. 15 shows yet another example process according to an embodiment. Process 1500 may be performed by processing logic that may comprise hardware (circuitry, dedicated logic, etc.), software (such as is run on a general purpose computer system or a dedicated machine), firmware, or a combination. In one embodiment, the process 1500 is performed by user device 110 and/or server 140 of FIG. 1.

Referring to FIG. 15, in operation 1510, user 105 may use user device 110 to request access to digital content from publisher's site or app 120. For example, user 105 may select (e.g., click or tap on) an article, try to make an in-game purchase, listen to a podcast, or download an app or game, etc. The user's request may be sent to server 140. The request sent to server 140 may include information of the content and user information (such as login, name, demographics, digital information, e.g., cookie information, browser fingerprints, browser, IP address, device, display, etc.) via CDN server 130. Server 140 may update content database 170 and user database 160 with these information. Server 140 may invoke its ads brands and offers management functions. Using user history, preferences, and analytics functions, server 140 may query SSP/ad network 175 and advertiser brands/offers database 165 to gather products or brands to display to user 105 on publisher website or app 120. Server 140 may update user database 160, advertiser brands/offers database 165, and content database 170.

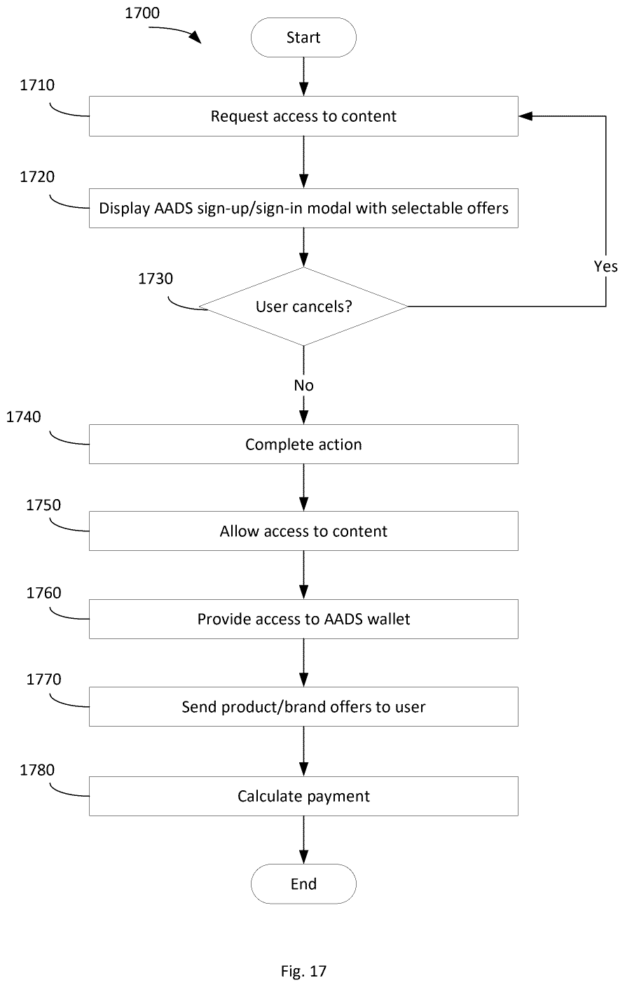

In operation 1520, an AADS wallet sign-up/sign-in modal with offers may be displayed to the user on publisher's website or app 120. Referring now to FIG. 16, which is a diagram illustrating an example AADS wallet sign-up/sign-in with offers modal displayed on a publisher's website according to an embodiment, modal 1600 may include a header or title 1610, message 1620, at least one brand or product UI element 1630, sign-up/sign-in fields 1640, cancel icon or button 1660, and button 1650 to agree and sign up. In this example, four brands 1630 may be displayed, though any number of brands may exist in other examples. Header 1610 may indicate to the user that the modal 1600 is from the AADS wallet system. Message 1620 may include a brief message on what user 105 may be required to agree to and may provide benefits information. UI element 1630 may show product names, pictures, videos, sound clips, logos, etc. A product may include a physical product (e.g., shoe, car, etc.), a digital product (e.g., software, app, podcast, video, music), a restaurant, airline, travel site, a service, insurance, etc. Sign-up/sign-in fields 1640 may include fields required for sign-up or sign-in, such as email, password, first name, and last name. In an embodiment, UI element 1630 is personalized by user personalization 190 based on user 105's preference.

Referring back to FIG. 15, in operation 1530, process 1500 may determine whether user 105 agrees to the conditions presented in the modal (e.g., modal 1600). If user 105 agrees to the conditions and signs up/signs in, process 1500 proceeds to operation 1540. Action information of user 105 may be sent to server 140, and any selections or interactions that user 105 made on the products/brands are displayed. If user 105 does not agree, process 1500 reverts to operation 1510.

In operation 1540, server 140 may authenticate the user and provide or allow access to the digital content for a limited time period (e.g., two weeks, 48 hours, etc.). Server 140 may update relevant databases (e.g., databases 160, 165, 170) with this information.

In operation 1550, user 105 may be provided with access to an AADS wallet. AADS wallet app download information may also be sent to user 105. AADS wallet website information may sent to user 105. Server 140 may update the relevant databases with this information.

In operation 1560, personalized product/brand offers may be sent to the user. In one embodiment, user 105 may be provided with a link to download an app (e.g., from the App Store or Play Store) or a product. In another embodiment, a link may be provided asking the user to complete a survey, sign up on a site, or request more information. Server 140 may update the relevant databases with this information. Based on user 105 communication preferences, offers may be sent to the user via email, SMS, other messaging apps/media, or in the wallet app.

In operation 1570, the revenue management function of server 140 may be invoked to calculate payment. The server may calculate payments owed to the publisher and payments owed by the advertisers. Relevant databases may be updated with this information.

AADS Wallet User Flow 2 with Clickable/Action-Oriented Offers

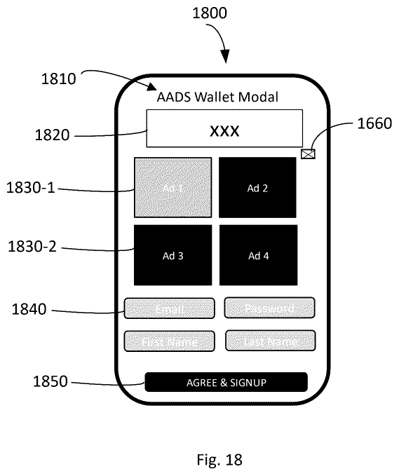

FIG. 17 shows still another example process according to an embodiment. Process 1700 may be performed by processing logic that may comprise hardware (circuitry, dedicated logic, etc.), software (such as is run on a general purpose computer system or a dedicated machine), firmware, or a combination. In one embodiment, the process 1700 is performed by user device 110 and/or server 140 of FIG. 1.

Referring to FIG. 17, in operation 1710, user 105 may use user device 110 to request access to digital content from publisher's site or app 120. For example, user 105 may select (e.g., click or tap on) an article, try to make an in-game purchase, listen to a podcast, or download an app or game, etc. The user's request may be sent to server 140. The request sent to server 140 may include information of the content and user information (such as login, name, demographics, digital information, e.g., cookie information, browser fingerprints, browser, IP address, device, display, etc.) via CDN server 130. Server 140 may update content database 170 and user database 160 with these information. Server 140 may invoke its ads brands and offers management functions. Using user history, preferences, and analytics functions, server 140 may query SSP/ad network 175 and advertiser brands/offers database 165 to gather products or brands to display to user 105 on publisher website or app 120. Server 140 may update user databases 160, advertiser brands/offers database 165, and content database 170.

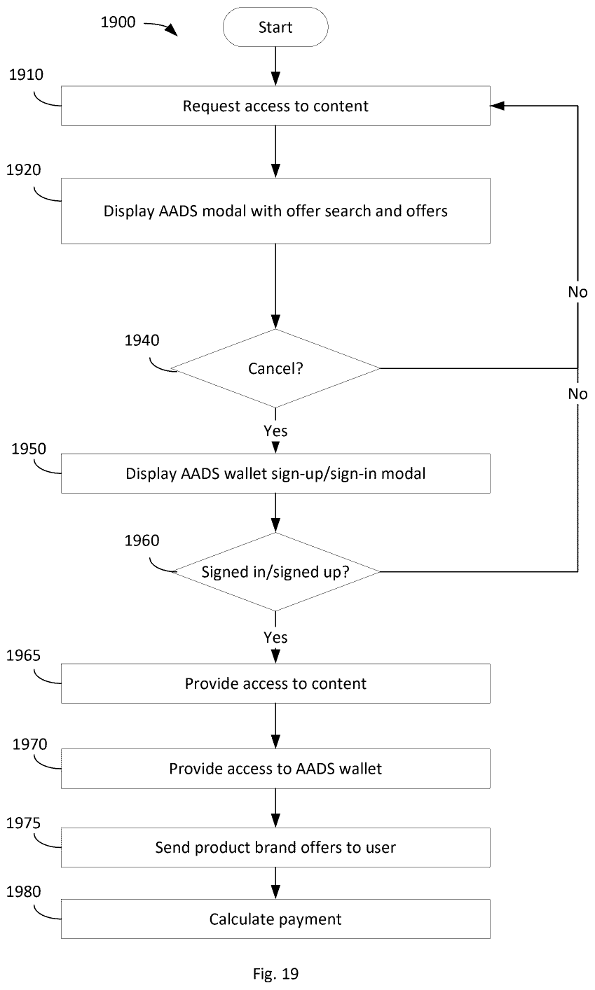

In operation 1720, an AADS wallet modal with actionable offers may be displayed to the user on publisher's website or app 120. Referring now to FIG. 18, which is a diagram illustrating an example AADS wallet with actionable offers modal displayed on a publisher's website according to an embodiment, modal 1800 may include a header 1810, message 1820, at least one ad UI element 1830, sign-up/sign-in fields 1840, cancel icon 1860, and button 1850 to agree and sign up. Header 1810 or title may indicate to the user that the modal is from the AADS wallet system. Message 1820 may provide a brief message on what user 105 may be required to agree to and may provide details of any benefits. Ad UI elements 1830 may show product names, pictures, videos, sound clips, logos, etc. A product may include a physical product (e.g., shoe, car, etc.), a digital product (e.g., software, app, podcast, video, music), a restaurant, airline, travel site, a service, insurance, etc. In this modal, at least one of ad UI elements 1830 is clickable. In this example, four ad UI elements 1830 are displayed (though any number of ad UI elements may be displayed), where an ad UI element 1830-1 is clickable, and the rest of ad UI elements 1830-2 are not. Upon clicking ad UI element 1830-1, for example, an offer may be revealed, a link to download an app or purchase a product, a link asking the user to perform any action, such as filling out a survey, signing up on a site, or requesting more information. Clickable ad UI element 1830-1 may have visual and other cues to indicate that they are clickable. If user 105 has an affinity for clickable ad UI element 1830-1, user 105 can immediately click on ad 2030 and benefit from the offer while accessing digital content. Advertisers may also benefit from this interaction with user 105 because they get instant feedback. As described previously, user personalization 190 presents offers or ads that have high rank and are intended to generate a positive attribution from user 105. UI elements 1830 are personalized based on user 105. Sign-up/sign-in fields 1840 may include fields required for sign-up or sign-in, such as email, password, first name, and last name.

Referring to FIG. 17, in operation 1730, method 1700 may check to see if user 105 cancels, for example, by clicking the cancel icon 1860. If user 105 cancels, method 1700 reverts to operation 1710. Otherwise, method 1700 proceeds to operation 1740. If the user does not cancel, it means that the user has clicked on one of the clickable ad UI element 1830-1, completed AADS wallet sign-in or sign-up, and agreed to the conditions presented in message 1820 (for example, clicking on button 1850).

In operation 1740, user 105 may complete any actions requiring follow-up by clicking ad UI element 1830-1. In an embodiment, the user may complete this action before they complete AADS wallet sign-in or sign-up (in operation 1730). For example, user 105 may have to complete downloading an app or digital product. This may require user 105 to finish authenticating themselves on the app/product network. In a different example, users may complete a survey or provide other information before completing the sign-in/sign-up. In another embodiment, this operation is optional. For example, the only requirement from the user is to click ad 2030-1 and reveal the offer. In yet another embodiment, multiple operations can be performed concurrently. For instance, the user may click ad UI element 1830-1 and complete the AADS wallet sign-up. In operation 1730, a different window may be opened for completing the action (e.g., download), and the method 1700 proceeds to the next operation (operation 1750).

In operation 1750, server 140 may authenticate the user and provide access to the digital content for a limited period (e.g., two weeks, 48 hours, etc.). Server 140 may update relevant databases with this information.

In operation 1760, user 105 may be provided access to the AADS wallet. AADS wallet app download details may also be sent to user 105. AADS wallet website details may be sent to user 105. Server 140 may update the relevant databases with this information.

In operation 1770, personalized product/brand offers may be sent to the user's wallet. In one embodiment, user 105 may be provided a link to download an app (e.g., from the App Store or Play Store) or a product. In another embodiment, a link may be provided asking the user to complete a survey, sign up on a site, or request more information. Server 140 may update the relevant databases with this information.

Based on user 105 communication preferences, offers may be sent via email, SMS, other messaging apps/media, or in the wallet app. This operation may be optional based on the required actions from modal 1800 presented to user 105.

In operation 1780, the revenue management function of server 140 may be invoked. The server may calculate payments owed to the publisher and payments owed by the advertisers. Relevant databases may be updated with this information.

AADS-Wallet User Flow 3 with Interactive Search Modal

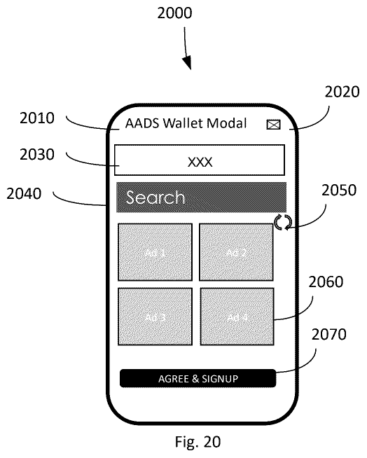

FIG. 19 shows an example method 1900 according to an embodiment. Method 1900 can be performed using system 100. Referring to FIG. 19, in operation 1910, user 105 may use user device 110 to request access to digital content from publisher's site or app 120. For example, user 105 may click on an article, try to make an in-game purchase, listen to a podcast, or download an app or game, etc. The user's request may be sent to server 140. The request sent to server 140 may include details of the content and the user (such as login, name, demographics, digital details-cookie information, browser fingerprints, browser, IP address, device, display, etc.) via CDN server 130.

Server 140 may update content database 170 and users database 160 with these details. Server 140 may invoke its ads brands and offers management functions. Using user history, preferences, and analytics functions, server 140 may query SSP/ad network 175 and advertisers brands/offers database 165 to gather products or brands to display to user 105 on publisher website or app 120. Server 140 may update users databases 160, advertiser brands/offers database 165, and content database 170.

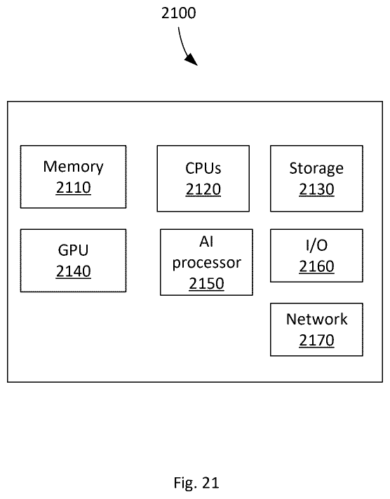

In operation 1920, an AADS wallet modal with search capability may be displayed to the user on publisher's website or app 120. FIG. 20 is an example of AADS wallet offers search modal 2000 displayed on publisher's website or app 120. Referring to FIG. 20, modal 2000 may include a header 2010, cancel icon 2020, message 2030, a search bar 2040, refresh icon 2050, at least one ad UI element 2060, and button 2050 to agree and sign up. Header 2010 or title may indicate to the user that the modal is from the AADS wallet system. Users can click on the icon (or UI element) 2020 to cancel modal 2000. Message 2030 may provide a brief message on what user 105 may be required to agree to and may provide details of any benefits. Search bar 2040 may provide user 105 with product search capability. Using search bar 2040, users can search specific brands or products, categories (e.g., shoes, kitchen knives, etc.), hot deals (e.g., promotional or heavily discounted items), offers with a specific period (e.g., travel packages in July), etc. Users can enter their search criteria and hit enter or click on refresh icon 2050 to refresh ads 2060 shown. In another embodiment, the user may click the refresh icon (button or UI element) 2050 to refresh ads 2060. When the user clicks the refresh icon 2050, server 140 may provide new products, brands, or ads. Ads UI element 2060 may show product names, pictures, videos, sound clips, logos, etc. A product may include a physical product (e.g., shoe, car, etc.), a digital product (e.g., software, app, podcast, video, music), a restaurant, airline, travel site, a service, insurance, etc. In an embodiment, some of the ad UI element 2060 are clickable. In this example, four ad UI elements 2060 are displayed, though any number of ad UI elements may be displayed. Clickable ad UI elements 2060 may have visual and other cues to indicate that they are clickable. If user 105 has an affinity for clickable ad UI element 2060, they can immediately click on ad 2030 and benefit from the offer while accessing digital content. Advertisers may also benefit from this interaction with user 105 because they get instant feedback. Once user 105 is satisfied with ad UI elements 2060, the user may click the button 2070 to accept the conditions presented on modal 2000.

Referring to FIG. 19, in operation 1940, method 1900 may check to see if user 105 cancels, for example, by clicking the cancel icon 2020. If user 105 cancels, method 1900 reverts to operation 1910. Otherwise, method 1900 proceeds to operation 1950.

In operation 1950, an AADS wallet sign-up or sign-in modal is shown to the user. For example, a modal 1400B is shown in FIG. 14B. In an embodiment, AADS wallet sign-up/sign-in can be performed using modal 2000. Method 2000 may skip operations 1940 and 1950 and proceed to operation 1960 after operation 1920.

In operation 1960, method 1900 may check if the user has completed the AADS wallet sign-in or sign-up. If the user has completed the sign-in (or sign up), method 1900 proceeds to operation 1965. Otherwise, method 1900 reverts to operation 1910.

In operation 1965, server 140 may authenticate the user and provide access to the digital content for a limited period (e.g., two weeks, 48 hours, etc.). Server 140 may update relevant databases with this information.

In operation 1970, user 105 may be provided with access to the AADS wallet. AADS wallet app download details may also be sent to user 105. AADS wallet website details may be sent to user 105. Server 140 may update the relevant databases with this information.

In operation 1975, personalized product/brand offers may be sent to the user's wallet. In one embodiment, user 105 may be provided a link to download an app (e.g., from the App Store or Play Store) or a product. In another embodiment, a link may be provided asking the user to complete a survey, sign up on a site, or request more information. Server 140 may update the relevant databases with this information.

Based on user 105 communication preferences, offers may be sent via email, SMS, other messaging apps/media, or in the Wallet App.

In operation 1980, the revenue management function of server 140 may be invoked. The server may calculate payments owed to the publisher and payments owed by the advertisers. Relevant databases may be updated with this information.

All examples and conditional language recited herein are intended for pedagogical purposes to aid the reader in understanding the principles of the present disclosure and the concepts contributed by the inventor to furthering the art and are to be construed as being without limitation to such specifically recited examples and conditions. Moreover, all statements herein reciting principles, aspects, and embodiments of the present disclosure, as well as specific examples thereof, are intended to encompass both structural and functional equivalents thereof. Additionally, it is intended that such equivalents include both currently known equivalents as well as equivalents developed in the future, e.g., any elements developed that perform the same function, regardless of structure.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

The foregoing descriptions of various specific embodiments in accordance with the present disclosure have been presented for purposes of illustration and description. They are not intended to be exhaustive or to limit the present disclosure to the precise forms disclosed, and many modifications and variations are possible in light of the above teaching. The present disclosure is to be construed according to the claims and their equivalents.

What is claimed is:

1. A computer-implemented method of providing access to digital content, the method comprising:
receiving, from a user device of a user, a request to access digital content;
in response to the request, providing the user device at least one modal for the user to sign-in or sign-up;
determining whether the user has signed in or signed up via the at least one modal;
in response to determining that the user has signed in or signed up via the at least one modal, providing the user access to the digital content for a specific time period;
sending to the user one or more offers about one or more products or brands;
providing the user access to a digital wallet; and
storing and providing a display of the one or more offers in the digital wallet.

2. The method of claim 1, further comprising:
computing a payment amount based on at least one of: the provided at least one modal or the one or more offers about the one or more products or brands.

3. The method of claim 1, wherein the at least one modal is displayed on the user device of the user.

4. The method of claim 3, wherein the at least one modal comprises a first modal having the one or more offers about the one or more products or brands.

5. The method of claim 4, wherein the one or more offers about the one or more products or brands are selectable by the user.

6. The method of claim 5, wherein the one or more offers are revealed or concealed.

7. The method of claim 4, wherein the first modal further has a search bar to search for a product or brand.

8. The method of claim 4, wherein the one or more offers about the one or more products or brands are refreshable to provide the user with one or more new offers about one or more new products or brands.

9. The method of claim 1, further comprising: providing customization of product or brand preferences in the digital wallet.

10. The method of claim 9, wherein sending to the user the one or more offers about the one or more products or brands comprises:
sending to the user the one or more offers about the one or more products or brands based on the product or brand preferences.

11. The method of claim 9, wherein the product or brand preferences are customized based on one or more user actions of the user.

12. The method of claim 11, wherein the one or more user actions comprise at least one of: saving the one or more offers, liking the one or more offers, ranking the one or more offers, or sharing the one or more offers with another user.

13. The method of claim 1, further comprising: providing the user with reward points or virtual currency in the digital wallet, wherein the reward points or virtual currency can be used for a purchase, or donated to or shared with another user.

14. The method of claim 1, wherein the digital wallet comprises a content history of digital contents accessed by the user, and a reward history of reward points or virtual currency earned by the user.

15. The method of claim 1, wherein determining whether the user has signed in or signed up via the at least one modal comprises determining whether the user has agreed, via the at least one modal, to receive a product offering.

16. The method of claim 1, wherein:
the request includes information of the digital content and user information of the user; and
the method further comprises:
updating a content database based on the information of the digital content; and
updating a user database based on the user information of the user.

17. The method of claim 1, further comprising: updating the one or more offers stored in the digital wallet.

18. A server system, comprising:
one or more processors; and
at least one memory coupled to the one or more processors and storing instructions, which when executed by the one or more processors, cause the server system to perform operations, the operations comprising:
receiving, from a user device of a user, a request to access digital content;
in response to the request, providing the user device at least one modal for the user to sign-in or sign-up;
determining whether the user has signed in or signed up via the at least one modal;
in response to determining that the user has signed in or signed up via the at least one modal, providing the user access to the digital content for a specific time period;
sending to the user one or more offers about one or more products or brands;
providing the user access to a digital wallet; and
storing and providing a display of the one or more offers in the digital wallet.

19. The server system of claim 18, wherein the operations further comprise:
computing a payment amount based on at least one of: the provided at least one modal or the one or more offers about the one or more products or brands.

20. The server system of claim 18, wherein the at least one modal is displayed on the user device of the user.

21. The server system of claim 20, wherein the at least one modal comprises a first modal having the one or more offers about the one or more products or brands.

22. The server system of claim 21, wherein the one or more offers about the one or more products or brands are selectable by the user.

23. The server system of claim 22, wherein the one or more offers are revealed or concealed.

24. The server system of claim 21, wherein the first modal further has a search bar to search for a product or brand.

25. The server system of claim 21, wherein the one or more offers about the one or more products or brands are refreshable to provide the user with one or more new offers about one or more new products or brands.

26. The server system of claim 18, wherein the operations further comprise: providing customization of product or brand preferences in the digital wallet.

27. The server system of claim 26, wherein sending to the user the one or more offers about the one or more products or brands comprises:
sending to the user the one or more offers about the one or more products or brands based on the product or brand preferences.

28. The server system of claim 26, wherein the product or brand preferences are customized based on one or more user actions of the user.

29. The server system of claim 28, wherein the one or more user actions comprise at least one of: saving the one or more offers, liking the one or more offers, ranking the one or more offers, or sharing the one or more offers with another user.

30. The server system of claim 18, wherein the operations further comprise: providing the user with reward points or virtual currency in the digital wallet, wherein the reward points or virtual currency can be used for a purchase, or donated to or shared with another user.

31. The server system of claim 18, wherein the digital wallet comprises a content history of digital contents accessed by the user, and a reward history of reward points or virtual currency earned by the user.

32. The server system of claim 18, wherein determining whether the user has signed in or signed up via the at least one modal comprises determining whether the user has agreed, via the at least one modal, to receive a product offering.

33. The server system of claim 18, wherein:
the request includes information of the digital content and user information of the user; and
the operations further comprise:
updating a content database based on the information of the digital content; and
updating a user database based on the user information of the user.

34. The server system of claim 18, wherein the operations further comprise: updating the one or more offers stored in the digital wallet.
